(19) United States
(12) Patent Application Publication
(10) Pub. No.: US 2008/0184789 A1
(43) Pub. Date: Aug. 7, 2008

(54) Method of operating a solar thermal process heat plant and solar thermal process heat plant

(75) Inventors: Markus Eck, Leonberg (DE); Tobias Hirsch, Stuttgart (DE); Stephan Koch, Zurich (SZ)

Correspondence Address: Lipsitz & McAllister, LLC, 755 MAIN STREET, MONROE, CT, 06468, US

(73) Assignee: Deutsches Zentrum fuer Luft- und Raumfahrt e.V., Koeln (DE)

(21) Appl. No.: 12/011,033

(22) Filed: Jan. 23, 2008

(30) Foreign Application Priority Data
Jan. 24, 2007 (DE) 10 2007 005 562.7

(51) Int. Cl. G01F 1/68

(52) U.S. Cl. 73/204.16

(57) ABSTRACT

There is proposed a method of operating a solar thermal process heat plant, in which a heat carrier medium is heated in a heating section by solar radiation, wherein the heating section comprises a plurality of heating branches, among which the heat carrier medium is distributed, comprising measuring at heating branches a state variable of the heat carrier medium, respectively, calculating a mean value of measured state variables over heating branches, and controlling mass flow control valves in the respective heating branches in dependence upon the respective deviation between the measured state variable of the flowing heat carrier medium in the respective heating branch and the calculated mean value.

The present disclosure relates to the subject matter disclosed in German application number 10 2007 005 562.7 of Jan. 24, 2007, which is incorporated herein by reference in its entirety and for all purposes.

### BACKGROUND OF THE INVENTION

The invention relates to a method of operating a solar thermal process heat plant, whereby a heat carrier medium is heated in a heating section (endothermally) by solar radiation, wherein the heating section comprises a plurality of heating branches, among which the heat carrier medium is distributed.

The invention further relates to a solar thermal process heat plant, comprising a heating section, in which a heat carrier medium is heatable (endothermally) by solar radiation, wherein the heating section comprises a plurality of heating branches connected in parallel.

Examples of solar thermal process heat plants are solar thermal power plants or solar thermal steam generation plants.

In solar thermal power plants a heat carrier medium is heated by solar radiation. The thermal energy of the heat carrier medium is (partially) converted in one or more turbines into mechanical energy. At one or more generators the mechanical energy is converted into electrical energy.

There are solar thermal power plants, in which superheated vapour is supplied to vapour turbines, and solar thermal power plants, which comprise gas turbines.

In the publication “Dynamic System Simulation and Design of the Separation System for Solar Direct Evaporation in Parabolic-Trough Collectors” by T. Hirsch, Progress Reports VDI, Series 6, No. 535, Dusseldorf: VDI-Verlag 2005, ISBN 3-18-353506-8, parabolic-trough power plants with direct evaporation are described.

### SUMMARY OF THE INVENTION

In accordance with the present invention, a method and a solar thermal plant are provided, with which even under a priori unknown operating conditions an evening-out of the outlet temperatures at the heating branches is achieved with a low variation range.

In accordance with the invention, at heating branches in each case a state variable of the heat carrier medium is measured, a mean value of measured state variables over heating branches is calculated, and mass flow control valves in the respective heating branches are controlled in dependence upon the respective deviation between the measured state variable of the flowing heat carrier medium in the respective heating branch and the calculated mean value.

In principle it is possible that the input mass flow into the heating branches is a priori unknown and that the pressure losses in the heating branches are unknown. Such a situation exists for example in superheating branches of a superheating section of a solar thermal power plant. Pressure losses are dependent upon line lengths and upon the insolation conditions as well as the respective mass flow. The situation may in this case be different in different heating branches.

By virtue of the solution according to the invention it is possible by generating the mean value over the heating branches (or at least over a majority of the heating branches) to achieve an evening-out of the state variables in the different pipes even under widely differing insolation conditions for the heating branches.

According to the invention there is provided a concept of how a total mass flow may be distributed among the heating branches and how the individual partial flows may be controlled with simultaneous evening-out of the state variable (such as for example temperature or vapour content).

Measurement of the mass flows as such is not necessary with the method according to the invention. The mass flows are adjusted or manipulated by means of the mass flow control valves without their absolute quantity having to be known.

It has emerged that with the method according to the invention, even given extreme transients in the insolation conditions and in the total mass flow, a stabilizing behaviour is achievable without a precise knowledge of the insolation conditions and of the input mass flow into the heating section being required. A low sensitivity to parameter variations is achievable.

The method according to the invention also has an auxiliary effect if additional control by injection of fluid heat carrier medium is provided.

By means of the method according to the invention the mass flow control valves may be operated in a cooperative, purposeful manner. The heating branches “assist” one another to a certain extent in the correction of an asymmetric insolation fault.

Also, with the method in accordance with the invention, the maximum temperature at each heating branch can be limited.

The deviation from the mean value can be characterized by, e.g., calculating a difference, a quotient, a minimum-maximum evaluation and so on. The deviation quality is, in particular, calculated by a process computer.

The concept according to the invention may be applied for example to the superheating section of a solar thermal power plant with direct evaporation or a steam generation plant. In this case, the total mass flow originates in particular from a central liquid-vapour separator.

It is for example also possible to realize the concept according to the invention on a tower receiver, wherein the heat carrier medium in this case can be gaseous.

The state variable at a heating branch may be measured once (per defined time interval) or a plurality of times. It may also be measured at spaced-apart locations of a heating branch.

In this case, it is possible in principle for each heating branch of the heating section to have a mass flow control valve or for only a subset of the heating branches to be provided with a mass flow control valve. It is further possible, when generating the mean value of the state variables, to take into account all or only some of the heating branches.

In particular it is provided that precisely one mass flow control valve is provided per heating branch if it has a mass flow control valve. This makes it easy to realize in particular proportional control.

It is advantageous if the heat carrier medium as it flows through the heating section is gaseous or vaporous or liquid or a multiphase mixture. It may therefore absorb sensible and/or latent heat.

It is provided that the heat carrier medium is split from a basic flow (input mass flow) into parallel partial flows, wherein the respective partial flows flow through respective heating branches. In the respective heating branches a heating of the heat carrier medium then occurs. The end result is to a certain extent a parallel heating of partial flows.

It is quite particularly advantageous if a (e.g., closed-loop) control circuit associated with the heating section is provided, in which adjusted (manipulated) variables are valve variables of the mass flow control valves and controlled variables are the respective state variables of the heat carrier medium in the respective heating branches. By means of the valve setting and in particular a valve lift the mass flow in the respective heating branch is adjustable. The adjustment is effected such that specific state variable values of the heat carrier medium are present at an outlet of the heating branch.

It is quite particularly advantageous if a target or setpoint variable for the controlled variables is the mean value of the state variables. The mean value is, e.g., an arithmetic average or weighted average. In this way it is possible to achieve a control response without the target variable as such having to be absolutely known. The mean value is determined continuously over time. A time adaptation of the setpoint variable for the controlled variables is therefore effected.

It has proved advantageous if the control circuit comprises PI controllers, which are associated with the respective heating branches and by means of which the mass flow control valves are controlled. By means of such proportional-plus-integral controllers an easy controllability is achieved.

It is advantageous if the state variables at different heating branches are measured at mutually corresponding points of the heating branches. It is thereby guaranteed that identical conditions are measured at different heating branches, so that the mean value of the state variable is a setpoint variable that is worth striving for. In particular, the state variables are measured with reference to mutually corresponding solar collector device of different heating branches.

In an advantageous manner, at the respective heating branch the state variable of the flowing heat carrier medium is measured at or in the vicinity of an outlet of a solar collector device. In this way, easy measurability is realized.

It is advantageous if at the respective heating branch the state variable of the flowing heat carrier medium is measured downstream of a penultimate solar collector device. This makes it easy to control the outlet state variable value of the heat carrier medium from the corresponding heating branch.

In particular, at the respective heating branch the state variable of the flowing heat carrier medium is measured at or in the vicinity of an outlet end of the heating branch. It is therefore possible for example, if the heat carrier medium is superheated vapour, to ensure that the liquid fractions in the heat carrier medium are minimized during measurement of the state variable. If an injection of fluid heat carrier medium is provided, then the state variable of the flowing heat carrier medium is advantageously measured upstream of the last solar collector device.

In the solution according to the invention, mass flow control in the heating branches is carried out without mass flow measurement, wherein the mass flow is manipulated by means of the mass flow control valves.

It may be provided that the mass flow control valves are started in an initial position, in which the valve setting is a partial lift of a possible complete lift or a complete lift. It is therefore possible to ensure that the mass flow control valves for varying the mass flow distribution may move in opposite directions, i.e. may not only open wider but also close. It is possible that the working point of the opening of the valve is controlled slowly.

In particular it is provided that the state variable of the heat carrier medium, which is measured and the mean value of which is determined, is the temperature of the heat carrier medium. In this case it is possible to use temperature measuring points that are in any case already provided.

If the heat carrier medium is multiphase, it may also be provided that the state variable, which is measured and the mean value of which is calculated, is the vapour content in the heat carrier medium.

It may be provided that at one or more heating branches the mass flow is reduced by means of at least one restrictor. It is therefore possible to set an operating point for the mass flow per heating branch.

In particular, the respective at least one restrictor is disposed at or in the vicinity of a single-phase flow region of the associated heating branch. In the case of a superheating branch, the arrangement at or in the vicinity of an outlet end is preferred. In the case of an evaporator pipe, the arrangement at or in the vicinity of an inlet end is preferred. In this way, the mass flow in the respective heating branch may easily be reduced.

It may be provided that at the respective heating branch (fluid or gaseous) heat carrier medium is injected. In this way, provision may be made for an additional state variable control and in particular temperature control, particularly if the heat carrier medium is not a single-phase fluid medium. It has emerged that a control by injecting fluid heat carrier medium and the control, which is based on mean-value generation, have only very little influence on one another. These two controls act in a supportive manner.

In this case, an injection at all heating branches may be provided, wherein one or more injection points may be provided per heating branch. It is also possible for injection to be provided only at a subset of the heating branches (having one or more injection points).

In particular, by means of the injection the state variable and/or an end temperature of the heat carrier medium on leaving the heating branch is controlled. It is therefore possible to reduce the variation of the state variables such as the temperature in the event of fluctuating insolation conditions.

It is advantageous if the injection is carried out upstream of a last solar collector device of the heating branch. The injection has to be carried out upstream of a solar collector device in order to allow evaporation of the liquid heat carrier medium. By means of the injection upstream of the last solar collector device the state variable and in particular temperature of the emerging heat carrier medium may be controlled and the maximum temperature at each heating branch is limited.

In particular, the injection occurs after the measurement of the state variable that is included in the mean-value generation. The two control concepts therefore influence one another at most only to a slight extent and even a form of mutual assistance is realized.

In an advantageous manner, the measurement of the state variable occurs prior to the injection and preferably the measurement of the state variable occurs upstream of the first injection point in a heating branch.

In particular, the injection is effected by means of a (e.g., closed-loop) control circuit, i.e. it is effected in a controlled manner.

It is advantageous if a controlled variable of the closed-loop control circuit is the state variable and/or the temperature of the heat carrier medium (on leaving the respective heating branch) and a manipulated variable is an injection quantity.

It is quite particularly advantageous if the control is carried out in such a way that a mass flow control valve under stationary conditions has a defined setting. For this purpose, there is provided in particular a slow feedback controller, which is part of the closed-loop control circuit. This ensures that a respective mass flow control valve is moved to a specific value (for example a mean value) if a stationary control response is achieved. In this way, a directional control with an optimized setting is achieved under stationary conditions.

It is advantageous if the respective heating branch comprises one or more solar collector devices. The heat carrier medium flows through these and in the process a heating process occurs.

In an embodiment, the at least one solar collector device takes the form of a focal-line collector. A focal-line collector has a linear focal region. Examples of focal-line collectors are parabolic-trough collectors and linear Fresnel collectors. The solar collector device can also be a tower receiver device or a segment of a tower receiver device.

In one embodiment, the heating section is a superheating section for vaporous heat carrier medium. In the superheating section, heat carrier medium that is already vaporous is superheated, wherein sensible heat is absorbed. In a further embodiment, the heating section is an evaporation section for heat carrier medium, which is liquid or comprises a liquid fraction.

The concept according to the invention is advantageously usable when the total flow of heat carrier medium that is supplied to the heating section is supplied by a central collection device like one or more liquid-vapour separators. The total flow supplied in this case is per se unknown and subject to fluctuations over time, which are traceable i.a. to fluctuating insolation conditions at an evaporator section.

In accordance with the invention, in the solar thermal process heat plant, at heating branches in each case a mass flow control valve is disposed, with the heating branches there is associated in each case one or more state variable sensors for measuring a state variable of flowing heat carrier medium, a (e.g., closed-loop) control device is provided, by means of which the mass flow control valves can be controlled, and a mean-value generating device is provided, by means of which a mean value of measured state variables over heating branches can be calculated, wherein the control of the mass flow control valve of a respective heating branch is dependent upon the state variable deviation between the respective measured state variable of the heat carrier medium in the respective heating branch and the calculated mean value over the heating branches.

By means of the solar thermal process heat plant according to the invention the method according to the invention may be realized.

A solar thermal process heat plant according to the invention may be operated with a low variation range of the state variable (for example the temperature) of the heat carrier medium that is supplied to the generator device. In this way, a high degree of efficiency is achieved.

The solar thermal process heat plant according to the invention may be a power plant with direct evaporation or for example a power plant, in which a gaseous heat carrier medium is used.

In particular, inputs of the mean-value generating device are connected to state variable sensors. The state variable sensors of the heating branches supply their measured values to the mean-value generating device, which may calculate the mean value over all or some of the heating branches.

It is further advantageous if outputs of the mean-value generating device are connected to controllers associated with the heating branches. These controllers may then, on the basis of the supplied information, bring about an appropriate control of the mass flow control valves.

It may be provided that the state variable sensors are temperature sensors. This is advantageous particularly if the heat carrier medium is single-phase. It is also possible to use temperature measuring points that are in any case provided.

It is for example also possible for the state variable sensors to be vapour content sensors if the heat carrier medium is a multiphase mixture.

In an advantageous manner, a distribution device is provided for splitting a total flow into partial flows for flowing through the heating branches. The partial flows are parallel flows, wherein the total flow need not a priori be known to allow mass flow control to be carried out.

It may be provided that one or more liquid-vapour separators are disposed upstream of the distribution device.

In particular, the liquid-vapour separator is a central separator, which is associated with a plurality of evaporator branches. In this case, the evaporator branches may themselves comprise solar collector devices.

Consequently, the heat carrier medium mass flow of vapour supplied by the liquid-vapour separator is a priori unknown as it is dependent upon the insolation conditions.

It may in particular be provided that the liquid-vapour separator is a separator of a recirculation device of the evaporator branches.

It is advantageous if the state variable sensors of different heating branches are disposed at mutually corresponding points. This makes it easier to even out the state variables over the heating branches because equivalent conditions exist for the state variable measurement.

In particular, a state variable sensor of a heating branch is disposed downstream of an output of a penultimate solar collector device. It is advantageous if a temperature sensor is disposed on a heating branch at or in the vicinity of an end of the heating branch. In this way, it is possible for example to ensure that the liquid fraction in flowing heat carrier medium is minimized. If the heating branch has an injection device, an arrangement of the state variable sensor upstream of the last solar collector device may be advantageous.

It is further advantageous if a state variable sensor is disposed on a heating branch at or in the vicinity of an outlet end of the heating branch. This makes it possible to determine the state variable while minimizing further influences. If for example the heat carrier medium is a vapour, then with this arrangement of a state variable sensor the liquid content is minimized during the measurement of the state variable.

It is quite particularly advantageous if a first (e.g., closed-loop) control circuit is provided, by means of which the mass flow control valves are controlled.

It is additionally possible to associate with a heating branch at least one injection device having one or more injection points for (liquid or gaseous) heat carrier medium. Thus, in addition to the (e.g., closed-loop) control of the mass flow, it is possible in the specific framework to control the state variable and/or the temperature of the heat carrier medium on leaving the heating branches.

In particular, the at least one injection device comprises a controller, by means of which a second closed-loop control circuit is formed, by means of which the injection of fluid heat carrier medium is controllable. By virtue of the injection of fluid heat carrier medium, a cooling effect may be achieved.

In an advantageous manner, the injection device of a respective heating branch is disposed downstream of a state variable sensor of the heating branch that supplies state variable values for mean-value generation. This means that the heat carrier medium, of which the state variable is determined for mean-value generation, is not influenced by the injection. This in turn means that it is possible to achieve a functional separation between the first closed-loop control circuit and a second closed-loop control circuit. The two control operations are then mutually supportive.

In particular, an injection device comprises a valve for regulating the injection quantity of fluid heat carrier medium. Thus, via the injection quantity the state variable value and in particular the temperature of the heat carrier medium may be controlled at an outlet of the corresponding heating branch.

It is further advantageous if the injection device comprises a state variable sensor and in particular a temperature sensor for determining the corresponding outlet temperature.

In particular, the state variable sensor is disposed downstream of an output of a solar collector device in order to determine the corresponding state variable. Advantageously, in this case the solar collector device is a last solar collector device of the heating branch.

It may be provided that one or more heating branches have at least one restrictor. The (at least one) restrictor is fixed or is permanently adjustable. This makes it possible to define an operating point. Differently adjusted restrictors may in this case be associated with different heating branches.

In an embodiment, a heating branch has a plurality of solar collector device and in particular a plurality of focal-line collectors. It is also possible for a heating branch to be realized for example on a tower receiver, wherein solar radiation is focused onto the heating branch by one or more heliostats.

The following description of preferred forms of construction is used in combination with the drawings to provide a detailed explanation of the invention.

### BRIEF DESCRIPTION OF THE DRAWINGS

FIG. 1 shows a diagrammatic representation of an embodiment of a solar thermal power plant according to the invention;

FIG. 2 shows a detail representation of a heating section (superheating section) of the solar thermal power plant according to FIG. 1;

FIG. 3 shows a diagram of the temperature dependence of a mixing temperature prior to entry into a generator device as a function of time, which was obtained by simulation of an embodiment of a power plant according to the invention, wherein a temperature mean value is shown and the temperature characteristic in differently irradiated heating branches; and

FIG. 4 shows a similar diagram to FIG. 3 when the method according to the invention is not used.

### DETAILED DESCRIPTION OF THE INVENTION

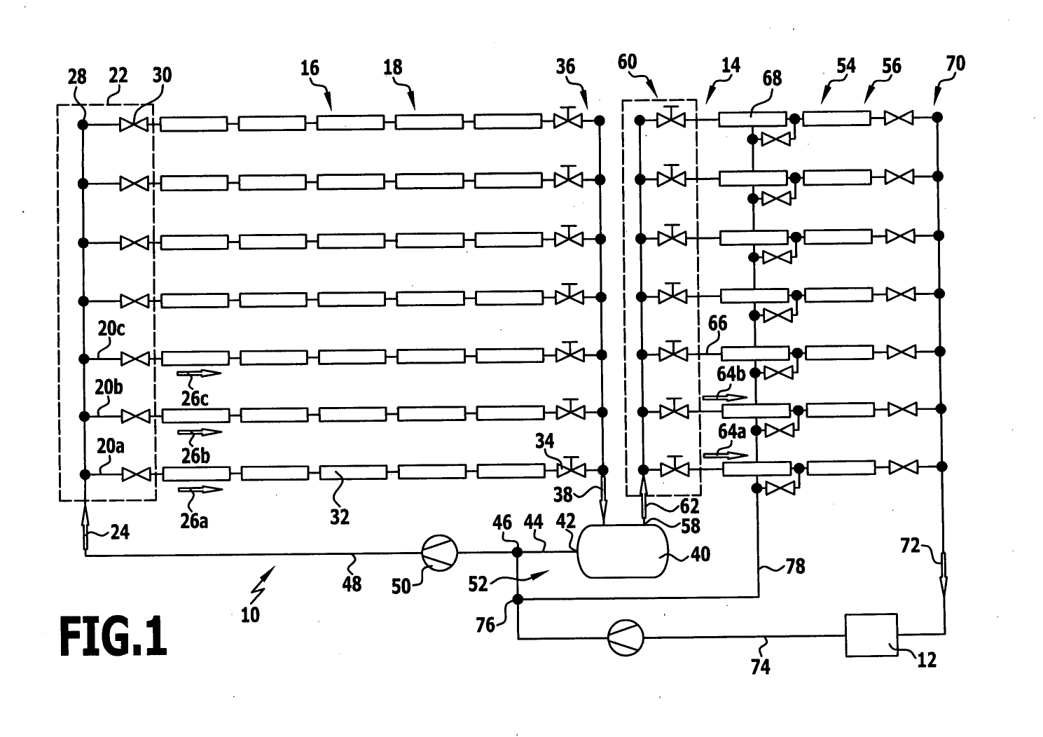

An embodiment of a solar thermal power plant according to the invention, as an example of a solar thermal process heat plant, which is shown diagrammatically in FIG. 1 and denoted there by 10, comprises a generator device 12 for generating electric current. The generator device 12 itself comprises one or more vapour turbines, at which thermal energy is converted into mechanical energy through expansion of a vaporous heat carrier medium, and one or more power generators, at which mechanical energy is converted into electrical energy. The vaporous heat carrier medium is supplied to the generator device 12 by means of a solar array 14.

The solar array 14 comprises a first heating section 16, which is an evaporator section 18. In the first heating section 16 liquid heat carrier medium, such as for example water, is evaporated.

The first heating section 16 comprises a plurality of evaporator branches 20a, 20b, 20c etc. These evaporator branches 20a, 20b, 20c etc., are connected in parallel. They are arranged parallel in a way that allows partial flows of a total flow to flow through them in parallel. This connection in parallel does not necessarily mean that the evaporator branches 20a, 20b, 20c etc., are disposed geometrically parallel.

The evaporator section 18 has a distribution device 22 for producing from a total flow 24 of liquid heat carrier medium partial flows 26a, 26b, 26c etc., which flow through the respective evaporator branches 20a, 20b, 20c etc.

The distribution device 22 for example comprises branches 28, the number of which corresponds to the number of evaporator branches 20a, 20b, 20c etc. The distribution device 22 for example further comprises controllable valves 30, the number of which corresponds to the number of evaporator branches. In particular, a respective valve 30 is disposed downstream of an associated junction.

The evaporator branches 20a, 20b, 20c etc., each comprise a plurality of serially disposed solar collector devices 32. Liquid heat carrier medium flows through these solar collector devices 32. In the process, heating is effected by solar radiation.

The solar collector devices 32 in particular take the form of focal-line collectors, which have a linear focal region, i.e. a focal region, which has an extent in a longitudinal direction that is much greater than the extent in a transverse direction at right angles thereto. Examples of focal-line collectors are parabolic-trough collectors and linear Fresnel collectors.

The evaporator branches 20a, 20b, 20c etc., have for example in each case a shut-off valve 34.

The evaporator section 18 has a collecting device 36, by means of which the partial flows 26a, 26b, 26c etc., are collected into a total flow 38. The total flow 38 is a vapour flow, which may contain liquid fractions.

An output of the collecting device 36 opens into a liquid-vapour separator 40, by means of which liquid and vapour may be separated.

A liquid output 42 of the liquid-vapour separator 40 is connected by a line 44 and a collector 46 to the distribution device 22, wherein between the collector 46 and the distribution device 22 there is a line 48. Disposed on the line 48 is a pump 50. The liquid-vapour separator 40 is a separator of a recirculation device 52, by means of which liquid may be fed back from the evaporator section 18. By the recirculation of liquid, uniform evaporation conditions may be obtained.

The liquid-vapour separator 40 is a central separator, which is associated with a plurality of evaporator branches of the evaporator section 18 and in particular with all of the evaporator branches of the evaporator section 18.

In the evaporator section 18 the heat carrier medium absorbs latent heat.

The first heating section 16 is followed by a second heating section 54, which is a superheating section 56. In the superheating section 56 the vaporous heat carrier medium absorbs sensible heat, wherein the heat source is solar radiation.

A vapour outlet 58 of the liquid-vapour separator 40 opens into a distribution device, which is denoted as a whole by 60 and by means of which a total flow 62 of vaporous heat carrier medium may be split into partial flows 64a, 64b etc.

The second heating section 54 comprises a plurality of heating sections 66, which are connected in parallel and which in the embodiment are superheating sections.

The distribution section 60 effects a parallel splitting of the total flow 62 into partial flows 64a, 64b etc., along the respective heating branches 66. The connection in parallel of the heating branches 66 does not necessarily mean that these are also arranged geometrically parallel.

The heating branches 66 each comprise a plurality of solar collector device 68. These are for example focal-line collectors as described above.

The second heating section 54 has a collecting device 70, by means of which the partial flows 64a, 64b etc., may be collected and a total flow 72 of superheated vaporous heat carrier medium may be produced. This total flow 72 is fed at a mixing temperature to the generator device 12.

From the generator device a line 74 leads to a junction 76. Fluid heat carrier medium that has arisen as a result of the expansion of vaporous heat carrier medium at one or more turbines flows through the line 74. An output of the junction 76 is connected to an input of the collector 46, so that fluid heat carrier medium is feedable through the line 48 to the distribution device 22.

From a further output of the junction 76 a line 78 leads to the second heating section 54. Through this line 78 fluid heat carrier medium may be supplied to the second heating section 54 and may be injected in particular for cooling purposes into injection pipes 66. This is explained in more detail below.

The solar thermal power plant comprises a closed-loop control device 80, which is associated with the second heating section 54 and by means of which the mass flows in the heating branches 66 are controllable so as to be adapted to the actual conditions.

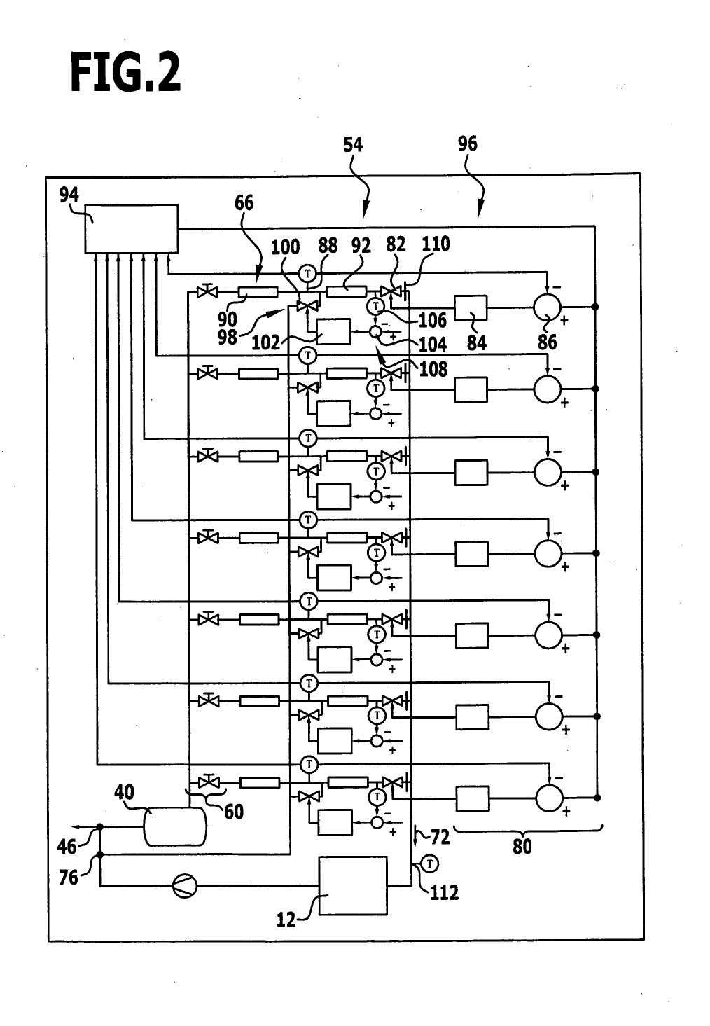

The heating branches 66 each have a mass flow control valve 82 controlled in each case by means of the closed-loop control device 80. By the valve setting of the mass flow control valves 82 the mass flow in the respective heating branches 66 is adjusted. A corresponding control device 84, which is part of the closed-loop control device 80, is symbolized in FIG. 2 by the reference character 84.

The closed-loop control device 80 comprises respective controllers 86 that are associated with the individual heating branches 66. These controllers are in particular PI controllers. They determine the control signal, by which the respective mass flow control valve 82 is controlled by means of the control device 84, and which valve setting and in particular which valve lift is set at the respective mass flow control valves 82.

Disposed on the respective heating branches 66 is (at least) one temperature sensor 88 that determines the temperature of the heat carrier medium flowing in the corresponding heating branch 66. It is preferably provided that the temperature sensors 88 of different heating branches 66 are disposed at mutually corresponding points, so that at different heating branches 66 mutually corresponding temperatures are measured.

The temperature sensors 88 are state variable sensors that measure, as the state variable, the temperature of the heat carrier medium. In this case, it is fundamentally possible to use a different state variable for the closed-loop control. For example, if the heat carrier medium is a multiphase mixture, it is possible to use the vapour content as a state variable, on which the closed-loop control is based. There now follows a description of the closed-loop control method based on the state variable, temperature.

It is preferred that the respective temperature sensors 88 are disposed at or in the vicinity of an end of the respective heating branches 66. This ensures that only the temperature of vaporous heat carrier medium is measured.

In FIG. 2 an embodiment is shown, in which an additional injection of fluid heat carrier medium is provided at the respective heating branches 66. In this case, the corresponding temperature sensors 88 are positioned between a penultimate solar collector device 90 and a last solar collector device 92 in the respective heating branch 66.

The temperature sensors 88 of the heating branches 66 are connected to a mean-value generating device 94, to which they supply their measuring signals. The mean-value generating device 94 contains all of the measured temperature values of the temperature sensors 88 of the heating branches 66. The mean-value generating device 94 may be part of the closed-loop control device 80 or be separate from this device.

From the temperatures of the vaporous heat carrier medium that are measured by the respective temperature sensors 88 at the heating branches 66, the mean-value generating device 94 calculates a mean value over the heating branches 66. The mean-value generation may in this case be effected over all of the heating branches 66 of the second heating section 54 or at least over a majority of the heating branches 66.

The nature of the mean-value generation may be dependent upon the particular circumstances. For example, an arithmetic mean value of the measured temperatures is determined or a geometric mean value. A different weighting of measured temperatures of different heating branches 66 may also be provided for the mean-value generation. For example, a central heating branch may have a different weighting than an outer-lying heating branch.

The mean-value generating device 94 is connected to the controllers 86; it supplies them with the calculated mean value.

The temperature sensors 88 are likewise connected to the corresponding controllers 86 and supply them with the measured temperature value.

The respective mass flow control valves 82 are controlled in accordance with a difference between the calculated mean value and the measured temperature value. If for example it emerges that the measured temperature is below the mean value, then the corresponding mass flow control valve 82 is opened wider. If it emerges that the measured temperature value is above the mean value, then the valve lift of the corresponding mass flow control valve 82 is reduced.

By means of the closed-loop control device 80 a first closed-loop control circuit 96 is formed, by which the mass flow in the respective heating branches 66 is controllable by means of the mass flow control valves 82 without the respective mass flow itself having to be measured.

With the heating branches 66 there is associated in each case (at least) one injection device 98 having one or more injection points, through which fluid heat carrier medium may be injected in particular for cooling purposes. The respective injection device 98 is in this case disposed in particular at the last solar collector device 92. Upstream of an input of this last solar collector device 92 fluid heat carrier medium may be injected in order to allow the outlet temperature of the vaporous heat carrier medium at the respective heating branch 66 to be influenced and in particular controlled.

The injection devices 98 in this case are connected to the line 78 that supplies fluid heat carrier medium.

The injection devices 98 each comprise a valve 100 that is subject to open-loop and/or closed-loop control. By means of this valve the injected fluid quantity may be adjusted. The respective valves are controlled in this case by respective associated control devices 102. Associated with these in turn are in each case controllers 104, which determine the control signals.

The respective injection devices 98 comprise a temperature sensor 106, which measures the temperature of the (vaporous) heat carrier medium at an output of the last solar collector device 92. The corresponding temperature signal is supplied to the controller 104. Depending on the deviation from a setpoint temperature, the corresponding valve 100 is controlled in order, by increasing or decreasing the injected fluid quantity, to achieve a temperature reduction or a temperature rise.

By means of the injection devices 98 second closed-loop control circuits 108 are formed, by means of which the temperature of the vaporous heat carrier medium as it leaves the corresponding heating branch 66 may be influenced.

It is preferably provided that the respective mass flow control valves 82 are disposed downstream of the last solar collector device 92 on the respective heating branches 66.

It is possible for heating branches to have in each case a restrictor 110. By means of this restrictor 110 it is possible in particular to adjust a maximum mass flow. The restrictor 110 may in this case be fixed or adjustable. By means of the restrictors 110 it is possible to fix a kind of operating point for the mass flow for the respective heating branches 66. The fixing may be effected in this case by suitably selecting and/or adjusting the individual restrictors 110 individually for the respective heating branches 66.

The solar thermal power plant 10 operates as follows:

Liquid heat carrier medium is supplied to the evaporator branches 20a, 20b, 20c of the first heating section 16. Solar heating leads to at least partial evaporation of the heat carrier medium. By means of the (central) liquid-vapour separator 40 a separation of liquid and vapour occurs. The (hot) separated liquid is recirculated. The vapour is fed to the second heating section 54 for superheating, i.e. for the absorption of sensible heat.

The pressure level in the respective heating branches 66 and in particular the pressure drop at the mass flow control valves 82 and the mass flows at the different heating branches 66 are a priori unknown because the mass flow of the total flow 62 is not a priori known. The pressure losses in the heating branches 66 depend upon the heating situation and the respective mass flows.

The heating situation may be different because of differing insolation conditions at the respective heating branches 66. Different line lengths may lead to different pressure losses.

In the solution according to the invention, mass flow control is effected by means of the closed-loop control device 80 without the mass flow itself having to be measured. The manipulated variable is the respective valve setting of the mass flow control valves 82, wherein the controlled variable is the temperature, which is measurable by means of the temperature sensors 88. The setpoint variable for these controlled variables in this case is the mean value of the corresponding temperatures over all of the heating branches 66 (or at least over the majority of the heating branches 66).

By means of the temperature sensors 88 the corresponding temperatures are continuously measured and supplied to the mean-value generating device 94, which continuously calculates a corresponding mean value. This mean value is assigned to the second heating section 54. From the difference of the measured temperature and the mean value the respective controllers determine a control signal, by means of which the respective mass flow control valves 82 are then individually continuously controlled.

The mass flow control valves 82 adapt the mass flow in the heating branches 66 in such a way that as identical a temperature (namely the mean temperature) and in particular outlet temperature as possible is achieved. The absolute value of this temperature in this case does not enter as direct information into the first closed-loop control circuit 96. Nor does an absolute setpoint value have to be defined for this outlet temperature. This makes it possible to take into account different energy inputs into the second heating section 54 and different input mass flows out of the liquid-vapour separator 44 and in particular their variation with time.

It may additionally be provided that the outlet temperature of the respective heating branches 66 is controlled by means of the associated injection devices 98. The corresponding second closed-loop control circuits 108 may be operated substantially independently of the first closed-loop control circuit 96. In this case, the controlled variable that is adjusted in the closed-loop control device 80 is the outlet temperature of the penultimate solar collector device 90 of the respective heating branches 66.

By means of the solution according to the invention, particularly given the use of a central liquid-vapour separator 40, it is possible to achieve an evening-out of the outlet temperatures out of the second heating section 54.

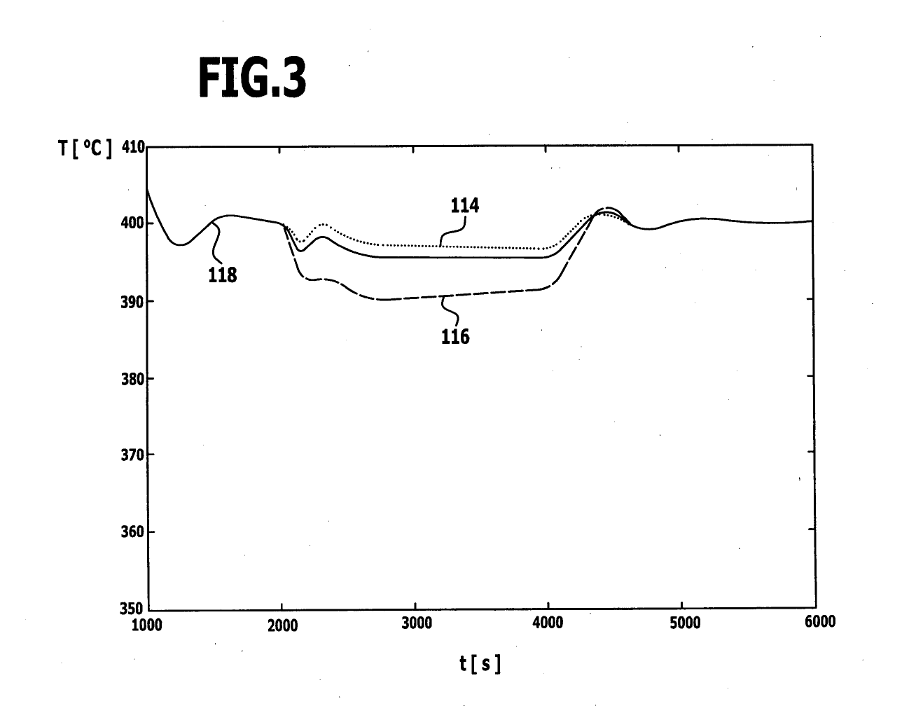

FIG. 3 shows a diagram of the time dependence of an outlet temperature in the case of the method according to the invention. The outlet temperature is the mixing temperature according to position 112 in FIG. 2. The diagram of FIG. 3 is based on a simulation of the method according to the invention when the second heating section 54 comprises seven heating branches 66, of which three heating branches are half-shaded for a specific period of time (starting from t=2000 s).

The heating branches each have two solar collectors, which are in each case 100 m long. The outlet pressure is 110 bar, which is assumed to be constant. Given heating of 900 W/m², the starting point is a vapour mass flow of 8.4 kg/s, which enters the system along the dew-point curve. If no injection occurs, the mixing temperature is around 430° C. An outlet temperature of 400° C. requires (in the stationary state) the injection of 0.067 kg/s water at a temperature of 275° C. The curve 114 shows the characteristic for the irradiated heating branches. The curve 116 shows the characteristic for the shaded heating branches. The curve 118 shows the characteristic of the resultant mixing temperature.

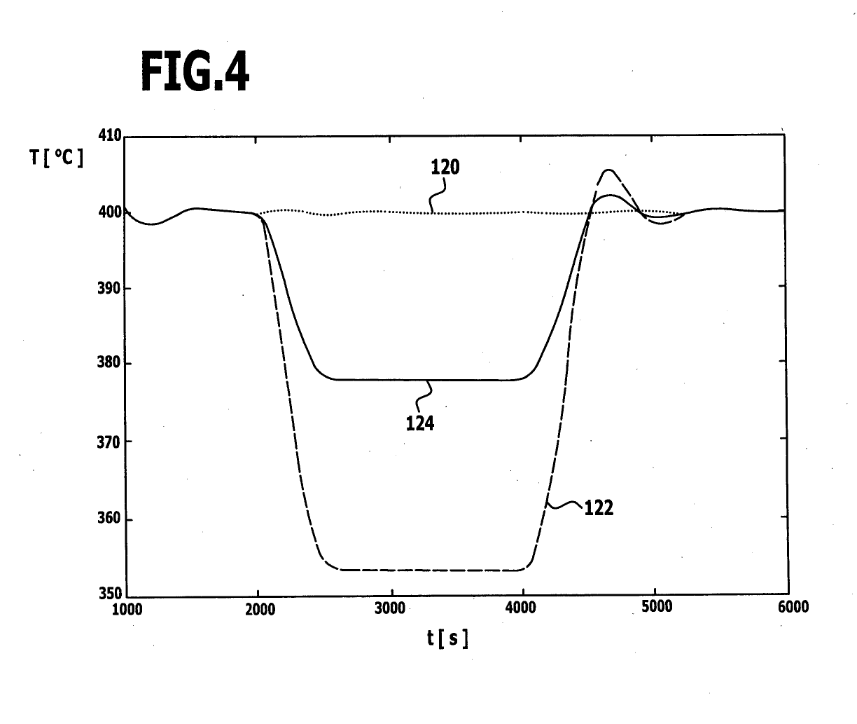

FIG. 4 shows the result of a similar simulation, in which the first closed-loop control circuit 96 is not provided and closed-loop control is effected only by injection cooling. The curve 120 belongs to the irradiated heating branches and the curve 122 to the non-irradiated heating branches. The mixing temperature has the characteristic 124.

From a comparison of FIGS. 3 and 4 it is evident that the temperature of the vaporous heat carrier medium fed to the generator device 12 has shorter variations when the control concept according to the invention is realized. Even in the case of widely differing insolation conditions the variation range may be kept small. By means of the solution according to the invention a total mass flow may be distributed among different heating branches, wherein the mass flow in the individual heating branches is controllable and the total mass flow 92, which is brought together and supplied to a generator device 12, has a small variation range.

Measurement of the individual mass flows is not necessary for the control method according to the invention. These individual mass flows are influenced by the mass flow control valves 92 without measurement.

By means of the solution according to the invention, even in the case of extreme transients in the insolation conditions and in the total mass flow, a stabilizing behaviour is obtained even when the input mass flow and the insolation intensity are unknown. The sensitivity to parameter variations and particularly in the case of the use of PI controllers is low.

If in addition second closed-loop control circuits 108 with injection cooling are provided, then the first closed-loop control circuit 96 acts supportively in order to obtain as uniform temperature conditions as possible at the outputs of the respective heating branches 66.

In the solution according to the invention, a calculated mean value is used to control the mass flows. The mass flow control valves 82 consequently interact in a purposeful manner. If for example an individual heating branch 66 is shaded, the result, there, is a high downward deviation from the temperature mean value. This leads to an extreme throttling of the mass flow in this particular heating branch 66. In the other heating branches 66 a slight increase of the mass flow occurs as a result of the respective mass flow control valves 82 opening wider because, there, there is an upward deviation from the temperature mean value. The result is therefore “mutual assistance” of the heating branches in the event of asymmetric disturbances of the insolation conditions.

It may for example be provided that the mass flow control valves 82 are started in a specific initial position in order to give rise to a variation of the mass flow distribution in opposite directions. The initial position is in particular a partial lift of the complete lift. For example, this partial lift is 60% of the complete lift. Simulation calculations have demonstrated that after the correction of asymmetric insolation conditions a return of the valve lift into the initial position occurs. A residual deviation should be compensated by means of a low-parameter integral-action controller having the valve setting as a controlled variable in order to ensure that the mass flow control valves 82 remain long-term in the control range.

In particular, it is provided that the closed-loop control at the heating branches is carried out by slow feedback controllers, which ensure that the feedback occurs in the direction of a defined value if a stationary control response occurs. This defined value is for example a middle setting of the corresponding mass flow control valve.

The concept according to the invention may be used for solar thermal power plants having an evaporator section and a superheating section.

It is for example also possible for the concept according to the invention to be realized at a solar thermal power plant, in which a gas (such as for example helium or air) is heated. For example, there may be provided on a tower receiver a plurality of heating branches connected in parallel, through which a-gaseous heat carrier medium flows. Here too, there may be different input mass flows and different insolation conditions at different heating branches. The individual mass flow control at the individual heating branches on the basis of a calculated mean value and controlling of mass flow control valves in dependence upon the difference between the measured temperatures and the mean value may also be carried out here.

1. Method of operating a solar thermal process heat plant, in which a heat carrier medium is heated in a heating section by solar radiation,
wherein the heating section comprises a plurality of heating branches, among which the heat carrier medium is distributed, comprising:
measuring at heating branches a state variable of the heat carrier medium, respectively;
calculating a mean value of measured state variables over heating branches; and
controlling mass flow control valves in the respective heating branches in dependence upon the respective deviation between the measured state variable of the flowing heat carrier medium in the respective heating branch and the calculated mean value.

2. Method according to claim 1, wherein precisely one mass flow control valve is provided per heating branch.

3. Method according to claim 1, wherein the heat carrier medium as it flows through the heating section is gaseous or vaporous or liquid or a multiphase mixture.

4. Method according to claim 1, wherein heat carrier medium is split from a basic flow into parallel partial flows, wherein the respective partial flows flow through respective heating branches.

5. Method according to claim 1, with a control circuit associated with the heating section, in which adjusted variables are valve settings of the mass flow control valves and controlled variables are the respective state variables of the heat carrier medium in the respective heating branches.

6. Method according to claim 5, wherein a target variable for the controlled variables is the mean value of the state variables.

7. Method according to claim 5, wherein the control circuit comprises PI controllers, which are associated with the respective heating branches and by means of which the mass flow control valves are controlled.

8. Method according to claim 1, wherein the state variables at different heating branches are measured at mutually corresponding points of the heating branches.

9. Method according to claim 1, wherein at the respective heating branch the state variable of the flowing heat carrier medium is measured at or in the vicinity of an outlet of a solar collector device.

10. Method according to claim 1, wherein at the respective heating branch the state variable of the flowing heat carrier medium is measured downstream of a penultimate solar collector device.

11. Method according to claim 1, wherein at the respective heating branch the state variable of the flowing heat carrier medium is measured at or in the vicinity of an outlet end of the heating branch.

12. Method according to claim 1, wherein mass flow control is carried out in the heating branches without mass flow measurement.

13. Method according to claim 1, wherein the mass flow control valves are started in an initial position, in which the valve setting is a partial lift of a possible complete lift or a complete lift.

14. Method according to claim 1, wherein the state variable is the temperature of the heat carrier medium.

15. Method according to claim 1, wherein the state variable is the vapour content in the heat carrier medium when the heat carrier medium is multiphase.

16. Method according to claim 1, wherein at one or more heating branches the mass flow is reduced by means of at least one restrictor.

17. Method according to claim 16, wherein the respective at least one restrictor is disposed at or in the vicinity of a single-phase flow region of the associated heating branch.

18. Method according to claim 1, wherein at the respective heating branch fluid heat carrier medium is injected.

19. Method according to claim 18, wherein by means of the injection the state variable and/or a final temperature of the heat carrier medium on leaving the heating branch is controlled.

20. Method according to claim 18, wherein the injection is carried out upstream of a last solar collector device of the heating branch.

21. Method according to claim 20, wherein the injection is effected after the measurement of the state variable that is included in the mean-value generation.

22. Method according to claim 18, wherein the injection is carried out by means of a control circuit.

23. Method according to claim 22, wherein a controlled variable of the control circuit is the state variable of the heat carrier medium and a manipulated variable is an injection quantity.

24. Method according to claim 1, wherein the closed-loop control is carried out in such a way that a mass flow control valve under stationary conditions has a defined setting.

25. Method according to claim 1, wherein the respective heating branch comprises one or more solar collector devices.

26. Method according to claim 25, wherein the at least one solar collector device takes the form of a focal-line collector.

27. Method according to claim 1, wherein the at least one solar collector device is a tower receiver device or a segment of a tower receiver device.

28. Method according to claim 1, wherein the heating section is a superheating section for vaporous heat carrier medium.

29. Method according to claim 1, wherein the total flow of heat carrier medium that is supplied to the heating section is supplied by one or more liquid-vapour separators.

30. Solar thermal process heat plant, comprising:
a heating section, in which a heat carrier medium is heatable by solar radiation;
wherein the heating section comprises a plurality of heating branches connected in parallel;
wherein at the heating branches or a majority of the heating branches a mass flow control valve is disposed, respectively;
one or more state variable sensors for measuring a state variable of flowing heat carrier medium associated with the heating branches, respectively;
a control device, by means of which the mass flow control valves are controllable; and
a mean-value generating device, by means of which a mean value of measured state variables over heating branches is calculable;
wherein the control of the mass flow control valve of a respective heating branch is dependent upon the state variable deviation between the respective measured state variable of the heat carrier medium in the respective heating branch and the calculated mean value over the heating branches.

31. Solar thermal process heat plant according to claim 30, wherein inputs of the mean-value generating device are connected to state variable sensors.

32. Solar thermal process heat plant according to claim 30, wherein outputs of the mean-value generating device are connected to controllers associated with the heating branches.

33. Solar thermal process heat plant according to claim 30, wherein the state variable sensors are temperature sensors.

34. Solar thermal process heat plant according to claim 30, wherein the state variable sensors are vapour content sensors.

35. Solar thermal process heat plant according to claim 30, with a distribution device for splitting a total flow into partial flows for flowing through the heating branches.

36. Solar thermal process heat plant according to claim 30, wherein one or more liquid-vapour separators are disposed upstream of the distribution device.

37. Solar thermal process heat plant according to claim 30, wherein a liquid-vapour separator is a central separator that is associated with a plurality of evaporator branches.

38. Solar thermal process heat plant according to claim 37, wherein the liquid-vapour separator is a separator of a recirculation device of the evaporator branches.

39. Solar thermal process heat plant according to claim 30, wherein the state variable sensors of different heating branches are disposed at mutually corresponding points.

40. Solar thermal process heat plant according to claim 30, wherein a state variable sensor of a heating branch is disposed downstream of an output of a penultimate solar collector device.

41. Solar thermal process heat plant according to claim 40, wherein a state variable sensor is disposed on a heating branch at or in the vicinity of an outlet end of the heating branch.

42. Solar thermal process heat plant according to claim 30, with a first control circuit, by means of which the mass flow control valves is controllable.

43. Solar thermal process heat plant according to claim 30, wherein at least one injection device having one or more injection points for fluid heat carrier medium is associated with a heating branch.

44. Solar thermal process heat plant according to claim 43, wherein the at least one injection device comprises at least one controller, by means of which a second control circuit is formed, by means of which the injection of fluid heat carrier medium is controllable.

45. Solar thermal process heat plant according to claim 43, wherein an injection point of a respective heating branch is disposed downstream of a state variable sensor of the heating branch that supplies state variable values for the mean-value generation.

46. Solar thermal process heat plant according to claim 43, wherein an injection device comprises a valve for controlling the injection quantity of fluid heat carrier medium.

47. Solar thermal process heat plant according to claim 43, wherein an output of the valve is disposed upstream of an input of a solar collector device.

48. Solar thermal process heat plant according to claim 43, wherein the injection device comprises at least one of a state variable sensor and a temperature sensor.

49. Solar thermal process heat plant according to claim 48, wherein the state variable sensor is disposed downstream of an output of a solar collector device.

50. Solar thermal process heat plant according to claim 43, wherein the injection device is associated with a last solar collector device of the heating branch.

51. Solar thermal process heat plant according to claim 30, wherein one or more heating branches has at least one restrictor.

52. Solar thermal process heat plant according to claim 30, wherein a heating branch has a plurality of solar collector devices.

53. Solar thermal process heat plant according to claim 52, wherein the solar collector devices are focal-line collectors.

54. Solar thermal process heat plant according to claim 30, wherein the heating section is at least partially arranged on a tower receiver.

55. Solar thermal process heat plant according to claim 30, wherein the plant is a solar thermal power plant.

56. Solar thermal process heat plant according to claim 55, wherein a generator device for the generation of electrical energy is provided.

57. Solar thermal process heat plant according to claim 30, wherein the plant is a steam generator plant.
